(19) United States
(12) Patent Application Publication
(10) Pub. No.: US 2025/0175811 A1
(43) Pub. Date: May 29, 2025

(54) MEASURING THE COVERAGE OF A COMPETING WIRELESS COMMUNICATIONS NETWORK

(71) Applicants: AT&T Intellectual Property I, L.P., Atlanta, GA (US); AT&T Mobility II LLC, Atlanta, GA (US)

(72) Inventors: Rory Darwin Pinili, Elgin, IL (US); Shomik Pathak, Richardson, TX (US); Yeshwant Dattatray Bhat, Watford (GB); Anwar Sayeed, Plano, TX (US); Rajkumar K. Amesur, Hillsborough, NJ (US); Saeed u Rashid Mir, Schaumburg, IL (US); Victoria L. Littlefield, Bond, OR (US); Jimmy Zong Qun Wang, Plano, TX (US); Mark Austin, Allen, TX (US); Wee Tak Ng, San Francisco, CA (US)

(21) Appl. No.: 18/523,852

(22) Filed: Nov. 29, 2023

(51) Int. Cl. H04W 16/26; H04W 24/08

(52) U.S. Cl. CPC H04W 16/26; H04W 24/08

(57) ABSTRACT

A method performed by a processing system including at least one processor includes sending an instruction to an application executing on a mobile device, where the instruction causes the application to configure the mobile device to measure and report a radio frequency of a first wireless communications access network, wherein the mobile device is subscribed to a service provided by a second wireless communications access network, receiving measurements of the radio frequency of the first wireless communications access network from the mobile device, and generating a coverage map illustrating a coverage of the first wireless communications access network, using the measurements.

The present disclosure relates generally to wireless communications networks and relates more particularly to devices, non-transitory computer-readable media, and methods for measuring the coverage of a competing wireless communications network.

### BACKGROUND

Within the context of wireless communications, “coverage” refers to the physical area within which the signals emitted by a wireless communications network are transmitted. Different wireless communications networks may have different coverage areas, and the coverage areas associated with two or more different wireless communications networks may even overlap.

### SUMMARY

In one example, the present disclosure describes a device, computer-readable medium, and method for measuring the coverage of a competing wireless communications network. For instance, in one example, a method performed by a processing system including at least one processor includes sending an instruction to an application executing on a mobile device, where the instruction causes the application to configure the mobile device to measure and report a radio frequency of a first wireless communications access network, wherein the mobile device is subscribed to a service provided by a second wireless communications access network, receiving measurements of the radio frequency of the first wireless communications access network from the mobile device, and generating a coverage map illustrating a coverage of the first wireless communications access network, using the measurements.

In another example, a non-transitory computer-readable medium stores instructions which, when executed by a processor, cause the processor to perform operations. The operations include sending an instruction to an application executing on a mobile device, where the instruction causes the application to configure the mobile device to measure and report a radio frequency of a first wireless communications access network, wherein the mobile device is subscribed to a service provided by a second wireless communications access network, receiving measurements of the radio frequency of the first wireless communications access network from the mobile device, and generating a coverage map illustrating a coverage of the first wireless communications access network, using the measurements.

In another example, a device includes a processor and a computer-readable medium storing instructions which, when executed by the processor, cause the processor to perform operations. The operations include sending an instruction to an application executing on a mobile device, where the instruction causes the application to configure the mobile device to measure and report a radio frequency of a first wireless communications access network, wherein the mobile device is subscribed to a service provided by a second wireless communications access network, receiving measurements of the radio frequency of the first wireless communications access network from the mobile device, and generating a coverage map illustrating a coverage of the first wireless communications access network, using the measurements.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for measuring the coverage of a competing wireless communications network, in accordance with the present disclosure;

FIG. 3 illustrates a first example coverage map for a first wireless communications access network and a second example coverage map for a second wireless communications access network;

FIG. 4 illustrates a flowchart of an example method for measuring the coverage of a competing wireless communications network, in accordance with the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure measures the coverage of a competing wireless communications network. As discussed above, within the context of wireless communications, “coverage” refers to the physical area within which the signals emitted by a wireless communications network are transmitted. Different wireless communications networks may have different coverage areas, and the coverage areas associated with two or more different wireless communications networks may even overlap.

An operator of a wireless communications network may plan where to locate physical infrastructure (e.g., base stations) in order to maximize the coverage of the wireless communications network. The operator may also choose to locate physical infrastructure to improve coverage in places where the coverage of a competing wireless communications network (i.e., a wireless communications network not owned or operated by the operator) is greater that the coverage of the operator's wireless communications network. However, while it may be relatively straightforward for the operator to measure the coverage of its own wireless communications network, existing means of measuring the coverage of a competing wireless communications network are less reliable, as well as time consuming and costly.

For instance, one common way of measuring the coverage of a competing wireless communications network is to utilize a mobile device (e.g., a mobile phone) to test and collect network performance metrics at various physical locations. However, this service is usually performed by a third party vendor, and availability tends to be limited to major cities. In less urban areas, a wireless communications network operator may measure the coverage of a competing wireless network by sending a drive team out in a vehicle with test devices (e.g., mobile phones, subscriber identification modules, tablet computers, laptop computers, and the like). But this approach is time consuming and costly, and coverage and repeatability are limited.

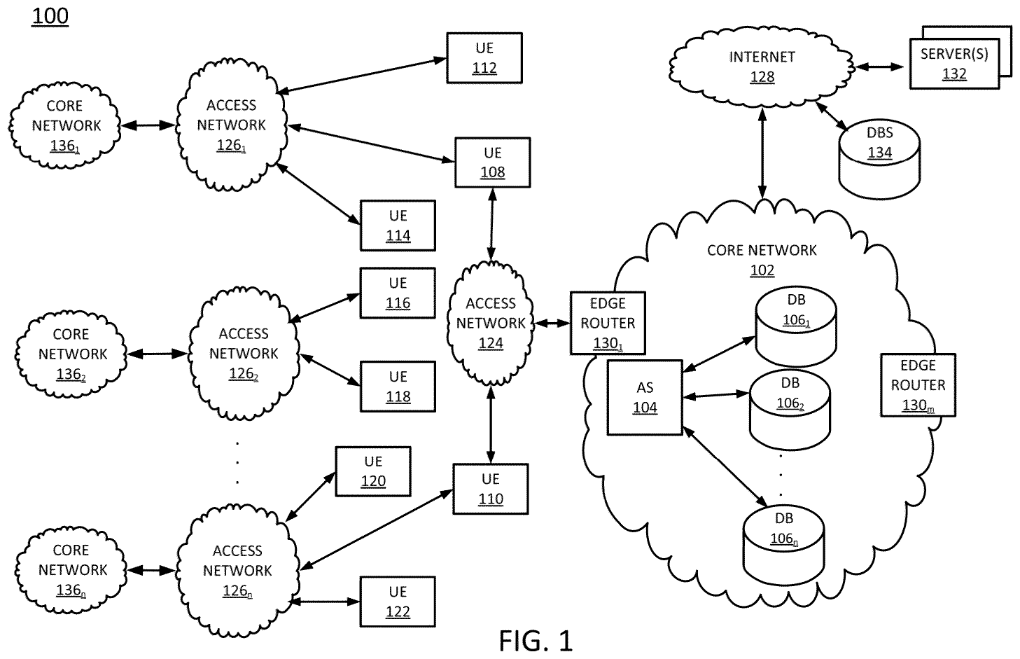

Examples of the present disclosure configure a first wireless communications network, such as a radio access network (RAN), so that user endpoint devices that are subscribed to services provided via the first wireless communications network report radio frequency (RF) measurements of a second wireless communications network to an application operated by an operator of the first wireless communications network. In one example, the application is created in a self-organizing network (SON). Measurements reported by the user endpoint devices may be used by the application to generate a coverage map showing the respective coverages of the first wireless communications network and the second wireless communications network. Based on the coverage map, the application may recommend modifications to an infrastructure of the first wireless network to improve coverage in physical locations where the coverage of the second wireless communications network is greater than the coverage of the first wireless communications network. These and other aspects of the present disclosure are discussed in greater detail in connection with FIGS. 1-5, below.

To further aid in understanding the present disclosure, FIG. 1 illustrates an example system 100 in which examples of the present disclosure for measuring the coverage of a competing wireless communications network may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks 124 and 126₁-126ₙ (hereinafter individually referred to as an “access network 126” or collectively referred to as “access networks 126”), and with the Internet 128. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include at least one application server (AS) 104, a plurality of databases (DBs) 106₁-106ₙ (hereinafter individually referred to as a “database 106” or collectively referred to as “databases 106”), and a plurality of edge routers 130₁-130ₘ (hereinafter individually referred to as an “edge router 130” or collectively referred to as “edge routers 130”). For ease of illustration, various additional elements of the core network 102 are omitted from FIG. 1.

In one example, the access networks 124 and 126 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 124 and 126. In one example, the access networks 124 and 126 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and at least some of the access networks 124 and 126 may be operated by different service providers, the same service provider or a combination thereof, or the access networks 124 and/or 126 may be operated by entities having core businesses that are not related to telecommunications services, e.g., corporate, governmental, or educational institution LANs, and the like. In one particular example, the access network 124 may be operated by a first wireless communications network operator, while the access networks 126 may comprise competing wireless communications networks operated by one or more different wireless communications network operators. In other words, the access networks 126 may be operated by a different entity or entities than the entity that operates the access network 124. For instance, each access network 126 may connect to a separate respective core network 136₁-136ₙ (hereinafter individually referred to as a “core network 136 or collectively referred to as “core networks 136”) that is separate from the core network 102 and operated by an entity that is different from the entity that operates the core network 102. Each of the core networks 136 may contain many of the same network elements contained in the core network 102.

In one example, the access network 124 may be in communication with one or more user endpoint devices (UEs) 108 and 110. Similarly, the access network 126₁ may be in communication with one or more UEs 112 and 114, the access network 126₂ may be in communication with one or more UEs 116 and 118, and the access network 126ₙ may be in communication with one or more UEs 120 and 122. The access networks 124 and 126 may transmit and receive communications between the UEs 108-122, between the UEs 108-122, the server(s) 132, the AS 104, other components of the core network 102, components of any of the core networks 136, devices reachable via the Internet in general, and so forth.

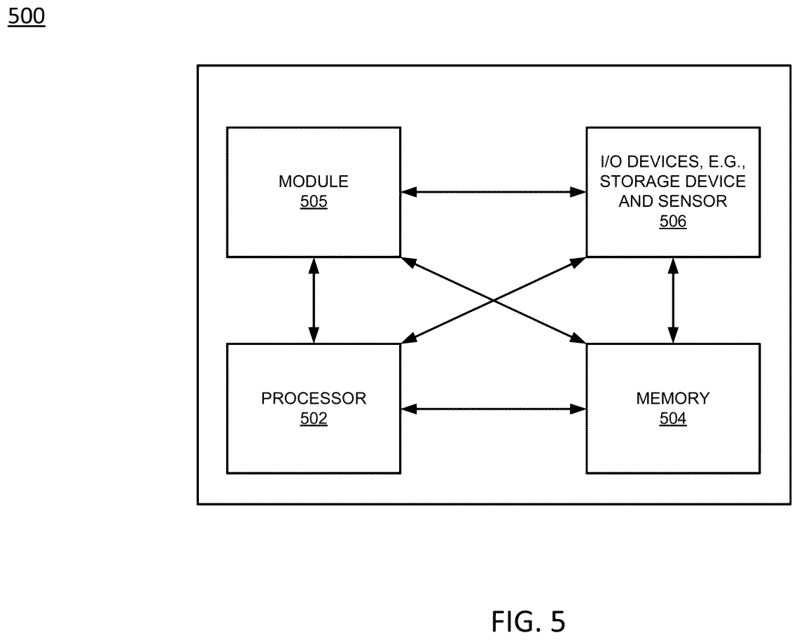

In one example, each of the UEs 108-122 may comprise a mobile device, a cellular smart phone, a wearable computing device (e.g., smart glasses, smart goggles, a virtual reality (VR) headset or other types of head mounted display, a smart watch, a fitness tracker, or the like), a gaming system, a laptop computer, a tablet computer, an autonomous vehicle (e.g., a drone or a self-driving automobile), or the like. In one example, each of the UEs 108-122 may comprise a computing system or device, such as computing system 500 depicted in FIG. 5, and may be configured to provide one or more operations or functions in connection with examples of the present disclosure for measuring the coverage of a competing wireless communications network.

In one example, one or more servers 132 and one or more databases 134 may be accessible to AS 104 via the Internet 128 in general. The server(s) 132 and DBs 134 may be associated with various data sources that collect data from the access networks 126. Thus, some of the servers 132 and DBs 134 may store content such as RF measurements of frequencies of the access networks 126 measured by the UEs 112-122.

In accordance with the present disclosure, the AS 104 may be configured to provide one or more operations or functions in connection with examples of the present disclosure for measures of the coverage of a competing wireless communications network, as described herein. The AS 104 may comprise one or more physical devices, e.g., one or more computing systems or servers, such as computing system 500 depicted in FIG. 5, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, the AS 104 may be configured to collect measurements of RF frequencies of the access networks 126, measured and reported by one or more of the UEs 108-122. The AS 104 may be further configured to generate one or more coverage maps illustrating the respective coverages of the access networks 126. The AS 104 may be even further configured to initiate an action to modify the coverage of the access network 124 in response to the information illustrated in the one or more coverage maps. For instance, the AS 104 may take an action such as temporarily deactivating a base station of the access network 124, activating a mobile base station of the access network 124, sending instructions to a mobile base station of the access network 124 to move to a new physical location, or the like.

Furthermore, in one example, at least some of the DBs 106 may operate as repositories for RF frequency measurements reported by the one or more UEs 108-122, prior to the RF frequency measurements being processed by the AS 104. For, instance each DB 106 may store RF frequency measurements associated with one access network 126 of the access networks 126. Thus, the DBs 106 may be continuously updated with new RF frequency measurements as new measurements are collected and reported by the one or more UEs 108-122.

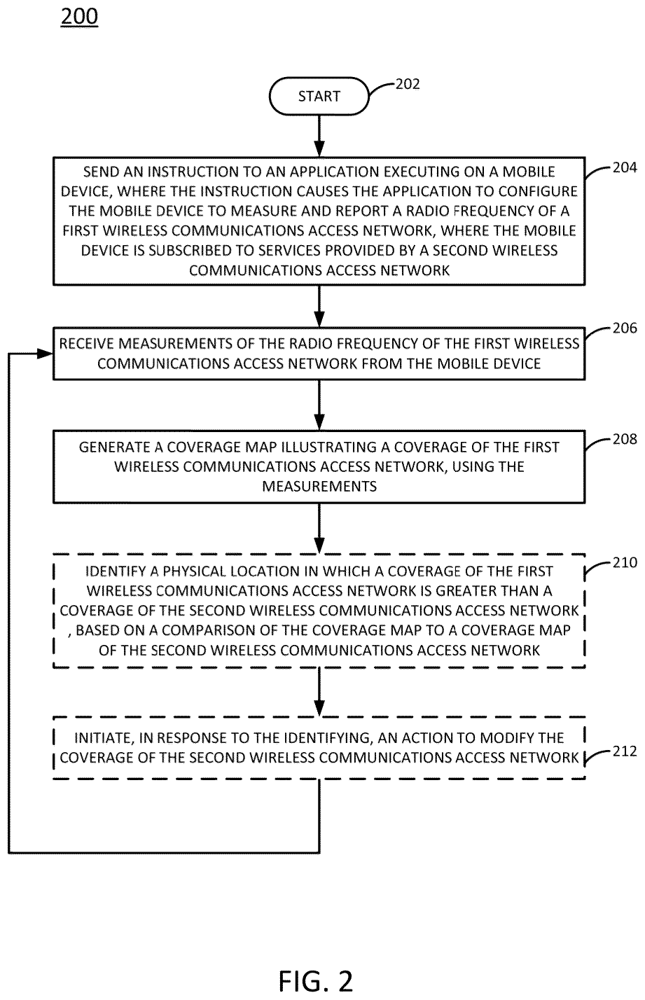

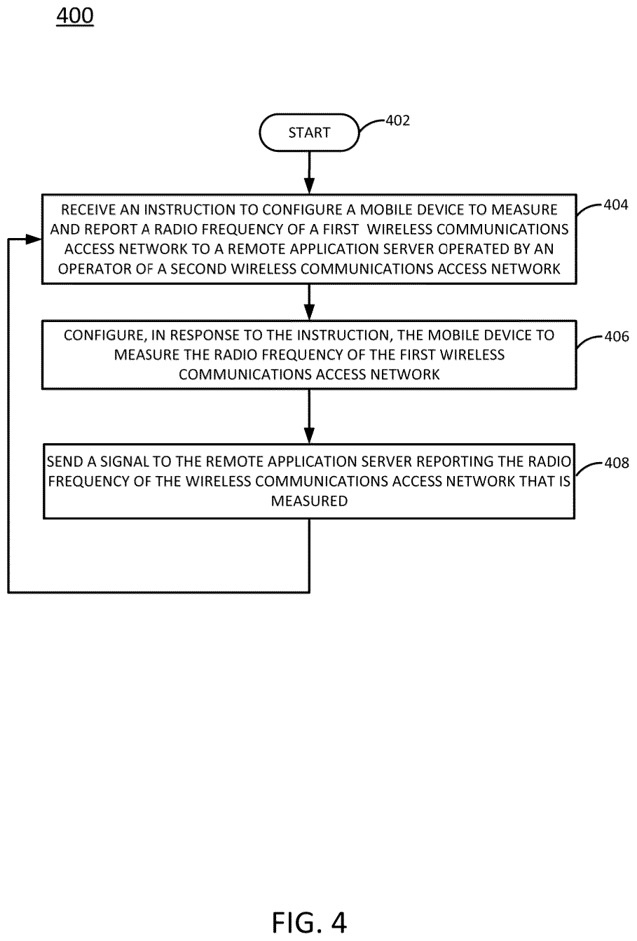

In one example, the DBs 106 may comprise physical storage devices integrated with the AS 104 (e.g., a database server or a file server), or attached or coupled to the AS 104, in accordance with the present disclosure. In one example, the AS 104 may load instructions into a memory, or one or more distributed memory units, and execute the instructions for measuring the coverage of a competing wireless communications network, as described herein. One example method for measuring the coverage of a competing wireless communications network is described in greater detail below in connection with FIGS. 2 and 4.

In operation, the AS 104 may be operated by an operator of the access network 124. The operator of the access network 124 may wish to measure the coverage of competing access networks 126 in order to optimize the coverage of the access network 124. In one example, the AS 104 may communicate with an application installed on at least some of the UEs 108-122. The UEs 108-122 on which this application is installed may comprise UEs of customers who are subscribed to wireless communications network services provided by the operator of the access network 124. In FIG. 1, some of the UEs 108-122 may comprise UEs of customers who are subscribed to services provided by the operator of the access network 124, while others of the UEs 108-122 may comprise UEs of customers who are subscribed to services provided by the operator of one of the other access networks 126.

The AS 104 may instruct the application installed on the UEs 108-122 to configure parameters of the UEs 108-122 to measure and report RF frequencies of the competing access networks 126. In one example, the AS 104 is able to remotely configure (i.e., via instructions to the application) the parameters of those of the UEs 108-122 that are connected to core network 102, but is unable to remotely configure the parameters of any of the UEs 108-122 that are not connected to the core network 102. Thus, in the example depicted in FIG. 1, the AS 104 may remotely configure the parameters of the UEs 108 and 110, but may be unable to remotely configure the parameters of the UEs 112-122. However, if either of the UEs 108 or 110 moves to a different core network (e.g., one of the core networks 136), then the AS 104 may no longer be able to configure the parameters of the UEs 108 or 110 that have moved.

Once the application has configured the parameters of those of the UEs 108-122 whose parameters can be configured (e.g., authorized to be configured by the AS 104), the configured UEs 108-122 may measure RF frequencies of the competing access networks 126 and may report the measured RF frequencies to the AS 104 or to a database 106 that stores RF frequency measurements for the competing access networks 126. The configured UEs 108-122 may measure and report the RF frequencies periodically (e.g., every x seconds), on-demand (e.g., in response to a query from the AS 104), in response to the detection of a predefined event (e.g., roaming to a competing access network 126 from another access network 124 or 126), and/or according to another schedule.

The AS 104 may process the RF frequencies measured and reported by the configured UEs 108-122 in order to generate one or more coverage maps. For instance, in one example, the AS 104 may generate a respective coverage map for each competing access network 126. The AS 104 may compare the one or more coverage maps to a coverage map for the access network 124, and may, in the course of the comparison, identify one or more physical locations in which the coverage of a competing access network 126 extends, but the coverage of the access network 124 does not extend. In response to identifying these one or more physical locations, the AS 104 may initiate an action to modify the coverage of the access network 124 (e.g., in order to extend the coverage of the access network 124 into at least one of the one or more physical locations that were identified). For instance, the AS 104 may send an instruction to a base station of the access network 124 to temporarily deactivate, may send an instruction to a mobile base station of the access network 124 to activate or to move to a new physical location, may generate a report indicating suggested locations for new fixed base stations of the access network 124, may send an instruction to change the signal beams (e.g., shape or power) of one or more antennas, or the like.

In some examples, a base station (e.g., an eNodeB or a gNodeB) of the access network may be configured to perform any or all of the above-described operations performed by the AS 104. For instance, the base station may act as an intermediary between the AS 104 and the configured or configurable UEs 108-122. The base station may relay instructions from the AS 104 to the configured or configurable UEs 108-122 and may relay measurements from the configured or configurable UEs 108-122 to the AS 104.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 124 and 126, and/or Internet 128 may comprise a content distribution network (CDN) having ingest servers, edge servers, and the like. Similarly, although only n+1 access networks, 124 and 126 are shown, in other examples, access networks 124 and/or 126 may each comprise a plurality of different access networks that may interface with the core network 102 independently or in a chained manner. For example, UEs 108-122 may communicate with the core network 102 via different access networks, UEs 108-122 may communicate with the core network 102 via the same access network, and so forth. Thus, these and other modifications are all contemplated within the scope of the present disclosure.

To further aid in understanding the present disclosure, FIG. 2 illustrates a flowchart of an example method 200 for measuring the coverage of a competing wireless communications network, in accordance with the present disclosure. In one example, the method 200 may be performed by an application server, such as the AS 104 or one of the servers 132 illustrated in FIG. 1. In another example, the method 200 may be performed by a base station of a radio access network (e.g., an eNodeB or a gNodeB). However, in other examples, the method 200 may be performed by another device, such as the processor 502 of the system 500 illustrated in FIG. 5. For the sake of example, the method 200 is described as being performed by a processing system.

The method 200 begins in step 202. In step 204, the processing system may send an instruction to an application executing on a mobile device, where the instruction causes the application to configure the mobile device to measure and report a radio frequency of a first wireless communications access network, wherein the mobile device is subscribed to services provided by a second wireless communications access network.

In one example, each of the first wireless communications access network and the second wireless communications access network may comprise a RAN. For instance, the first wireless access network may comprise a RAN operated by a first service provider, while the second wireless access network may comprise a RAN operated by a second service provider, different from the first service provider. The second service provider may provide a service to which a user of the mobile device is subscribed. The second service provider may utilize an application executing on the mobile device (as well as on the mobile devices of other subscribers who subscribe to the service provided by the second service provider) in order to measure the coverage of the first wireless communications access network, as described in further detail below.

For instance, even though the mobile device may belong to a subscriber of the second wireless communications access network, the mobile device may occasionally utilize the first wireless communications access network in order to access services and applications while roaming (e.g., outside of the coverage area of the second wireless communications access network). During these times, the mobile device may be able to measure a radio frequency of the first wireless communications access network.

In one example, the instruction sent to the application may cause the application to configure one or more parameters of the mobile device in order to enable the mobile device to measure and report the radio frequency of the first wireless communications access network. In one example, the parameters that are configured, and the manner in which those parameters are configured or set, may vary depending on the type (e.g., mobile phone, tablet computer, wearable device, drone, etc.), manufacturer, and/or model of the mobile device.

For instance, for a first make of cellular phone, one or more of the following parameters may be configured: an evolved universal mobile telecommunications system terrestrial radio access absolute radio frequency channel number (EARFCN) of the first wireless communications access network may be added to an evolved universal mobile telecommunications system terrestrial radio access (E-UTRAN) frequency of the mobile device, inter-frequency handovers may be enabled, or a cell trace profile may be activated for performance management-initiated measurement events. For a second make of cellular phone, one or more of the following parameters may be configured: a handover parameter to neighboring inter-frequency LTE cells (LNHOIF) may be added to the mobile device for each cell of the first wireless communications access network or the parameters of the LNHOIF may be modified so that an inter-frequency handover (i.e., mobility in connected mode between two different cells and different LTE frequencies) is triggered whenever an RF signal strength of the serving cell becomes worse than a first threshold while the RF signal strength of a neighboring cell becomes better than a second threshold (also referred to as an “A5 event within the context of LTE communications).

In one example, the instruction may further define a schedule by which the mobile device is to measure the radio frequency of the first wireless communications access network. The schedule may be defined to minimize any impact of the measurements and reporting on the transport or key performance indicators of the first wireless communications access network or the second wireless communications access network.

In one example, the signal may be sent indirectly via a base station of the second wireless communications access network. For instance, the processing system may send the signal directly to the base station, which may, in turn, send the signal to the application executing on the mobile device.

In step 206, the processing system may receive measurements of the radio frequency of the first wireless communications access network from the mobile device. In one example, each measurement of the measurements that are received may comprise a tuple including EARFCN that is measured and a location (e.g., geographic coordinates, such as latitude and longitude) at which the EARFCN was measured. In one example, EARFCN measurements may include at least one of: RF signal strength, RF signal quality, or signal-to-interference ratio.

In one example, the measurements may be received indirectly via a base station of the second wireless communications access network. For instance, the mobile device may send the measurements directly to the base station, which may, in turn, send the measurements to the processing system.

In step 208, the processing system may generate a coverage map illustrating a coverage of the first wireless communications access network, using the measurements. In one example, the coverage map may be generated in accordance with any one or more known methods for generating a coverage map. In one example, the coverage map may comprise a map of a physical location onto which data indicating RF signal strength (e.g., EARFCN) is superimposed. For instance, points may be placed on the map to correspond to physical locations at which RF signal strength was measured and recorded. The appearance (e.g., color, shade, density, or the like) of the points may vary according to the RF signal strength that was measured. For instance, a point that is colored in a darker shade may indicate a stronger RF signal, while a point that is colored in a lighter shade may indicate a weaker RF signal. In one example, EARFCN measurements represented in the coverage map may include RF signal quality and/or signal-to-interference ratio as well as RF signal strength.

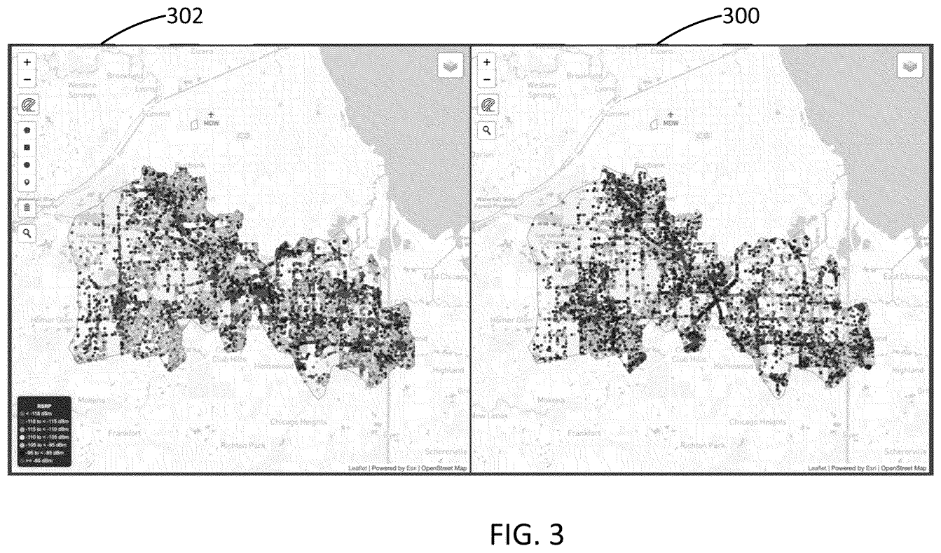

FIG. 3, for instance, illustrates a first example coverage map 300 for a first wireless communications access network and a second example coverage map 302 for a second wireless communications access network. Notably, each coverage map 300 and 302 does not depict the coverage of an entire corresponding wireless communications access network, but depicts the coverage of a corresponding wireless communications access network in a limited geographic area.

In optional step 210 (illustrated in phantom), the processing system may identify a physical location in which the coverage of the first wireless communications access network is greater than a coverage of a second wireless communications access network, based on a comparison of the coverage map of the first wireless communications access network to a coverage map of the second wireless communications access network.

In one example, the coverage of the first wireless communications access network may be “greater” than the coverage of the second wireless communications access network in a physical location when the coverage of the first wireless communications access network extends into the physical location, but the coverage of the second wireless communications access network does not extend into the physical location. In another example, the coverage of the first wireless communications access network may be “greater” than the coverage of the second wireless communications access network in a physical location when the RF signal strength of the first wireless communications access network is stronger in the physical location that the RF signal strength of the second wireless communications access network.

For instance, referring again to FIG. 3, the processing system may determine due to the density of points in the first coverage map 300 and the second coverage map 302 that although the coverage of the first wireless communications access network and the coverage of the second wireless communications access network both extend into the area north of Chicago Heights, the RF signal strength of the first wireless communications access network in this area is stronger than the RF signal strength of the second wireless communications access network in this area.

In optional step 212 (illustrated in phantom), the processing system may initiate, in response to the identifying, an action to modify the coverage of the second wireless communications access network. In one example, the action may comprise an action to extend coverage of the second wireless communications access network into a physical location where the coverage of the second wireless communications access network does not currently extend. In another example, the action may comprise an action that increases or otherwise improves the RF signal strength and/or RF signal quality (e.g., EARFCN) in a physical location where the coverage of the second wireless communications access network currently exists, but is perhaps not as great as the RF signal strength and/or RF signal quality of the first wireless communications access network in that physical location. In another example, the action may comprise an action that decreases or otherwise improves the RF signal-to-interference ratio in a physical location where the coverage of the second wireless communications access network currently exists, but is perhaps higher than the signal-to-interference ratio of the first wireless communications access network in that physical location.

In one example, the action may comprise one or more of: sending an instruction to a base station of the second wireless communications access network to temporarily deactivate, sending an instruction to a mobile base station of the second wireless communications access network to activate or to move to a new physical location, generating a report indicating suggested locations for new fixed base stations of the second wireless communications access network, change a signal beam (e.g., shape and/or power) of one or more antennas, or the like.

The method 200 may return to step 206 and may repeat some or all of steps 206-212 periodically, so that the processing system continuously receives measurements of the radio frequency of the first wireless communications access network.

It should be noted that multiple iterations of the method 200 may be performed simultaneously for a plurality of mobile devices that each send measurements of the radio frequency of the first wireless communications access network to the processing system. Thus, any of steps 204-212 may involve sending instructions to, receiving measurements from, and/or generating and comparing coverage maps based on measurements recorded by multiple mobile devices. Moreover, the multiple iterations of the method 200 may be performed simultaneously for a plurality of competing (e.g., first) wireless communications access networks.

FIG. 4 illustrates a flowchart of an example method 400 for measuring the coverage of a competing wireless communications network, in accordance with the present disclosure. In one example, the method 400 may be performed by a user endpoint device executing an application installed thereon, such as any of the UEs 112-122 illustrated in FIG. 1. However, in other examples, the method 400 may be performed by another device, such as the processor 502 of the system 500 illustrated in FIG. 5. For the sake of example, the method 400 is described as being performed by a processing system.

The method 400 begins in step 402. In step 404, the processing system may receive an instruction to configure a mobile device to measure and report a radio frequency of a first wireless communications access network to a remote application server operated by an operator of a second wireless communications access network. In one example, each of the first wireless communications access network and the second wireless communications access network may comprise a RAN. For instance, the first wireless access network may comprise a RAN operated by a first service provider, while the second wireless access network may comprise a RAN operated by a second service provider, different from the first service provider. The second service provider may provide a service to which a user of the mobile device is subscribed. The second service provider may utilize an application executing on the mobile device (as well as on the mobile devices of other subscribers who subscribe to the service provided by the second service provider) in order to measure the coverage of the first wireless communications access network (and/or other wireless communications access networks), as discussed above in connection with FIG. 2.

For instance, as discussed above, even though the mobile device may belong to a subscriber of the second wireless communications access network, the mobile device may occasionally utilize the first wireless communications access network in order to access services and applications while roaming (e.g., outside of the coverage area of the second wireless communications access network). During these times, the mobile device may be able to measure a radio frequency of the first wireless communications access network.

In one example, the signal may be sent indirectly via a base station of the second wireless communications access network. For instance, the processing system may receive the signal directly from the base station, which may, in turn, receive the signal from the remote application server.

In step 406, the processing system may configure, in response the instruction, the mobile device to measure the radio frequency of the first wireless communications access network. In one example, the instruction may cause the application to configure one or more parameters of the mobile device in order to enable the mobile device to measure and report the radio frequency of the first wireless communications access network. In one example, the parameters that are configured, and the manner in which those parameters are configured or set, may vary depending on the type, make, and/or model of the mobile device.

For instance, for a first make of cellular phone, one or more of the following parameters may be configured: an EARFCN of the first wireless communications access network may be added to a E-UTRAN frequency of the mobile device, inter-frequency handovers may be enabled, or a cell trace profile may be activated for performance management-initiated measurement events. For a second make of cellular phone, one or more of the following parameters may be configured: a LNHOIF parameter may be added to the mobile device for each cell of the first wireless communications access network or the parameters of the LNHOIF may be modified so that an inter-frequency handover (i.e., mobility in connected mode between two different cells and different LTE frequencies) is triggered whenever an RF signal strength of the serving cell becomes worse than a first threshold while the RF signal strength of a neighboring cell becomes better than a second threshold (also referred to as an “A5 event” within the context of LTE communications).

In one example, the instruction may further define a schedule by which the mobile device is to measure the radio frequency of the first wireless communications access network. The schedule may be defined to minimize any impact of the measurements and reporting on the transport or key performance indicators of the first wireless communications access network and/or the second wireless communications access network. It should be noted that the configuration is only implemented on authorized UEs (e.g., UEs subscribing to services of AS 104 and/or UEs previously provided their consents to such configuration for taking such measurements (e.g., opting in)).

In step 408, the processing system may send a signal to the remote application server reporting the radio frequency of the first wireless communications network that is measured. In one example, the processing system may send the signal directly to the remote application server. In another example, the processing system may send the signal directly to a base station of the second wireless communications access network, which may, in turn, relay the signal to the remote application server for further processing and analysis.

The method 400 may return to step 404 and may repeat some or all of steps 404-408 periodically, so that the processing system continuously measures and reports measurements of the radio frequency of the first wireless communications access network to the remote application server.

Although not expressly specified above, one or more steps of the method 200 or method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200 or method 400 may be implemented as the system 500. For instance, an application server (such as might be used to perform the method 200) or a mobile device (such as might be used to perform the method 400) could be implemented as illustrated in FIG. 5.

As depicted in FIG. 5, the system 500 comprises a hardware processor element 502, a memory 504, a module 505 for measuring the coverage of a competing wireless communications network, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for measuring the coverage of a competing wireless communications network may include circuitry and/or logic for disabling carrier aggregation in a cell deploying a carrier that supports beamforming and activating MU-MIMO communications. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for measuring the coverage of a competing wireless communications network (e.g., a software program comprising computer-executable instructions) can be loaded into memory 504 and executed by hardware processor element 502 to implement the steps, functions or operations as discussed above in connection with the example method 200 or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for measuring the coverage of a competing wireless communications network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
sending, by a processing system including at least one processor, an instruction to an application executing on a mobile device, where the instruction causes the application to configure the mobile device to measure and report a radio frequency of a first wireless communications access network, wherein the mobile device is subscribed to a service provided by a second wireless communications access network;
receiving, by the processing system, measurements of the radio frequency of the first wireless communications access network from the mobile device; and
generating, by the processing system, a coverage map illustrating a coverage of the first wireless communications access network, using the measurements.

2. The method of claim 1, wherein each of: the first wireless communications access network and the second wireless communications access network comprises a radio access network.

3. The method of claim 1, wherein at least one parameter of the mobile device to be configured according to the instruction varies according to at least one of: a type of the mobile device, a manufacturer of the mobile device, or a model of the mobile device.

4. The method of claim 3, wherein the at least one parameter of the mobile device includes at least one of: an addition of an evolved universal mobile telecommunications system terrestrial radio access absolute radio frequency channel number of the first wireless communications access network to an evolved universal mobile telecommunications system terrestrial radio access frequency of the mobile device, an enablement of inter-frequency handovers, or an activation of a cell trace profile for performance management-initiated measurement events.

5. The method of claim 3, wherein the at least one parameter of the mobile device include at least one of: an addition of a handover parameter to neighboring inter-frequency LTE cells to the mobile device for each cell of the first wireless communications access network or a trigger that causes an inter-frequency handover to occur when a radio frequency signal strength of a serving cell becomes worse than a first threshold while the a radio frequency signal strength of a neighboring cell becomes better than a second threshold.

6. The method of claim 1, wherein the instruction further defines a schedule by which the mobile device is to measure the radio frequency of the first wireless communications access network.

7. The method of claim 6, wherein the schedule is defined to minimize an impact of measurement and reporting of the radio frequency on at least one of: a transport of the first wireless communications access network, a key performance indicator of the first wireless communications access network, a transport of the second wireless communications access network, or a key performance indicator of the second wireless communications access network.

8. The method of claim 1, wherein the measurements of the radio frequency include an evolved universal mobile telecommunications system terrestrial radio access absolute radio frequency channel number of the first wireless communications access network and a physical location at which the evolved universal mobile telecommunications system terrestrial radio access absolute radio frequency channel number of the first wireless communications access network was measured.

9. The method of claim 1, further comprising:
identifying, by the processing system, a physical location in which the coverage of the first wireless communications access network is greater than a coverage of a second wireless communications access network, based on a comparison of the coverage map of the first wireless communications access network to a coverage map of the second wireless communications access network; and
initiating, by the processing system in response to the identifying, an action to modify the coverage of the second wireless communications access network.

10. The method of claim 9, wherein the coverage of the first wireless communications access is greater than the coverage of the second wireless communications access network in a physical location when the coverage of the first wireless communications access network extends into the physical location, but the coverage of the second wireless communications access network does not extend into the physical location.

11. The method of claim 9, wherein the coverage of the first wireless communications access network is greater than the coverage of the second wireless communications access network in a physical location when a radio frequency signal strength of the first wireless communications access network is stronger in the physical location that a radio frequency signal strength of the second wireless communications access network.

12. The method of claim 9, wherein the action comprises an action to extend the coverage of the second wireless communications access network into a physical location where the coverage of the second wireless communications access network does not currently extend.

13. The method of claim 9, wherein the action comprises an action that increases a radio frequency signal strength of the second wireless communications access network in a physical location where the coverage of the second wireless communications access network currently exists, but is not as strong as a radio frequency signal strength of the first wireless communications access network in the physical location.

14. The method of claim 9, wherein the action comprises sending an instruction to a mobile base station of the second wireless communications access network to activate.

15. The method of claim 9, wherein the action comprises sending an instruction to a mobile base station of the second wireless communications access network to move to a new physical location.

16. The method of claim 9, wherein the action comprises generating a report indicating a suggested location for a new fixed base station of the second wireless communications access network.

17. The method of claim 1, further comprising:
repeating the sending, the receiving, and the generating for additional mobile devices that are subscribed to the service provided by the second wireless communications access network.

18. The method of claim 17, wherein the generating uses the measurements received from the mobile device as well as measurements received from the additional mobile devices.

19. A non-transitory computer-readable medium storing instructions which, when executed by a processing system including at least one processor, cause the processing system to perform operations, the operations comprising:
sending an instruction to an application executing on a mobile device, where the instruction causes the application to configure the mobile device to measure and report a radio frequency of a first wireless communications access network, wherein the mobile device is subscribed to a service provided by a second wireless communications access network;
receiving measurements of the radio frequency of the first wireless communications access network from the mobile device; and
generating a coverage map illustrating a coverage of the first wireless communications access network, using the measurements.

20. A device comprising:
a processing system including at least one processor; and
a computer-readable medium storing instructions which, when executed by the processing system, cause the processing system to perform operations, the operations comprising:
sending an instruction to an application executing on a mobile device, where the instruction causes the application to configure the mobile device to measure and report a radio frequency of a first wireless communications access network, wherein the mobile device is subscribed to a service provided by a second wireless communications access network;
receiving measurements of the radio frequency of the first wireless communications access network from the mobile device; and
generating a coverage map illustrating a coverage of the first wireless communications access network, using the measurements.
